(19) United States
(12) Patent Application Publication
(10) Pub. No.: US 2008/0228506 A1
(43) Pub. Date: Sep. 18, 2008

(54) Optimized Deployment Solution

(76) Inventors: Stephen Oates, Georgetown, TX (US); Kevin Hanes, Round Rock, TX (US); Marc Jarvis, Belton, TX (US); Jefferson Raley, Austin, TX (US)

Correspondence Address: HAMILTON & TERRILE, LLP, P.O. BOX 203518, AUSTIN, TX, 78720, US

(21) Appl. No.: 11/685,407

(22) Filed: Mar. 13, 2007

(51) Int. Cl. G06Q 99/00

(52) U.S. Cl. 705/1

(57) ABSTRACT

An optimized deployment solution which uses a front-end to automatically drive deployment of an information handling system. The optimized deployment solution queries multiple data locations and creates a manifest that is used to automate the deployment. The optimized deployment solution decreases an amount of interaction that is needed from a technician thus decreasing the potential for technician failures.

### BACKGROUND OF THE INVENTION

This application relates to co-pending U.S. patent application Ser. No. ______, attorney docket number DC-12038, filed on an even date herewith, entitled “Client Deployment Optimization Mode,” naming Kevin Hanes, Steven Bodnar, Stephen Oates, Jefferson Raley and Gregory Bomsta as inventors, which is incorporated herein by reference in its entirety.

This application relates to co-pending U.S. patent application Ser. No. ______, attorney docket number DC-12039, filed on an even date herewith, entitled “Method for Information Handling System Deployment Assessment,” naming Kevin Hanes, Gregory Bomsta, Stephen Oates and Jefferson Raley as inventors, which is incorporated herein by reference in its entirety.

This application relates to co-pending U.S. patent application Ser. No. ______, attorney docket number DC-12042, filed on an even date herewith, entitled “Method to Determine Software Rationalization for Optimizing Information Handling System Deployments,” naming Jefferson Raley, Gregory Bomsta, Kevin Hanes, Stephen Oates and Kurt Stonecipher as inventors, which is incorporated herein by reference in its entirety.

### FIELD OF THE INVENTION

The present invention relates to providing information handling system services and more particularly to optimizing deployment solutions when deploying information handing systems.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems, especially within large scale information handling system installations, an important issue relates to the service and support of the large scale information handling system installations (i.e., installations in which more than a few information handling systems are supported by a single entity). The large scale information handling system installation provides an information handling system environment.

There are a number of issues that arise when deploying information handling systems or when performing in-place migrations of current information handling systems.

One known issue when deploying information handling systems relates to infrastructure constraints. More specifically, an industry standard solution to information handling system deployment assumes some basic requirements are met to deploy systems. The requirements include at least one of a network infrastructure that can sustain multiple gigabytes (GB) of data being pushed or pulled across the network, a database structure to control the build (e.g., a Sql database structure) and a deployment mechanism to push or pull applications (e.g., a Systems Management Server (SMS) deployment mechanism available from Microsoft Corporation or an Altiris deployment mechanism available from Symantec Corporation ). The requirements can place a strain on a customer's network and can add additional complexity to an initial setup of the deployment process.

Another known issue when deploying information handling systems relates to technician complexity. Often, when deploying information handling systems, technicians are expected to follow an install guide that instructs the technician step by step how to perform the deployment. Often this guide can be 30 to 40 pages long and is completely manual. The process of following such an install guide lends itself to failures related to mistakes with data entry or by missing steps outlined in the manual.

Another known issue when deploying information handling systems relates to logistical complexity. Logistical complexity arises during a deployment by requiring that a certain information handling system having certain bits loaded be deployed to the correct user.

One known attempt at addressing these issues is the Zero-Touch Business Desktop Deployment (BDD) solution available from Microsoft. The Zero-Touch BDD solution assumes all of the requirements set forth above been met to deploy systems. Meeting these requirements can place a strain on the customer's network and can adds additional complexity to the initial setup of the process.

A Lite-Touch version of the BDD solution is also known. The Lite-Touch version requires many decisions be made by the technician with regard to what will be installed on the information handling system. These decisions can make a deployment susceptible to failures related to missed steps or user error and still requires a portion of the aforementioned infrastructure be in place.

### SUMMARY OF THE INVENTION

In accordance with the present invention, an optimized deployment solution is set forth which uses a front-end to automatically drive deployment of an information handling system. The optimized deployment solution queries multiple data locations and creates a manifest that is used to automate the deployment. The optimized deployment solution decreases an amount of interaction that is needed from a technician thus decreasing the potential for technician failures.

The optimized deployment solution loads images in the factory while the information handling system is being fabricated. The optimized deployment solution pre-stages content such as multiple customer images, multiple customer applications, data migration tools, installation automation tools and other requirements onto the memory of the information handling system within the factory and ships generic systems to the end users. When the system is booted at the customer's site, the system loads a Windows Preinstallation Environment (WINPE) which executes a deployment customized front-end. This deployment customized front-end gathers all data necessary to drive the install. The deployment customized front end loads the image and applications and moves user specific data to the new system. All data is loaded from the pre-staged memory and thus greatly reduces the load on the customer network.

The optimized deployment solution simplifies the logistical complexity of deploying information handling systems by loading images in the factory. The loaded images enable the deployed information handling systems to include pre-staged content on memory while in the factory and ships generic systems to the end users. Thus the optimized deployment solution enables shipping deployed systems to an end user where the deployed information handling system can be easily customized and installed at the users' desk.

In one embodiment, the invention relates to a method for optimizing deployment of an information handling system which includes loading a superset of content onto the information handling system, generating a manifest representing content to be loaded onto the information handling system, and loading content from the superset of content based upon the manifest.

In another embodiment, the invention relates to an apparatus for optimizing deployment of an information handling system which includes means for loading a superset of content onto the information handling system, means for generating a manifest representing content to be loaded onto the information handling system, and means for loading content from the superset of content based upon the manifest.

In another embodiment, the invention relates to an information handling system which includes memory coupled to a processor. The memory stores a deployment optimization tool for optimizing deployment of an information handling system. The tool includes instructions for loading a superset of content onto the information handling system, generating a manifest representing content to be loaded onto the information handling system, and loading content from the superset of content based upon the manifest.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system on which the deployment and evaluation tool is executed.

FIG. 2 shows a block diagram of a deployment and evaluation tool.

FIG. 3 shows a flow diagram of the operation of the deployment and evaluation tool.

FIG. 4 shows a flow chart of the operation of a deployment optimization tool.

### DETAILED DESCRIPTION

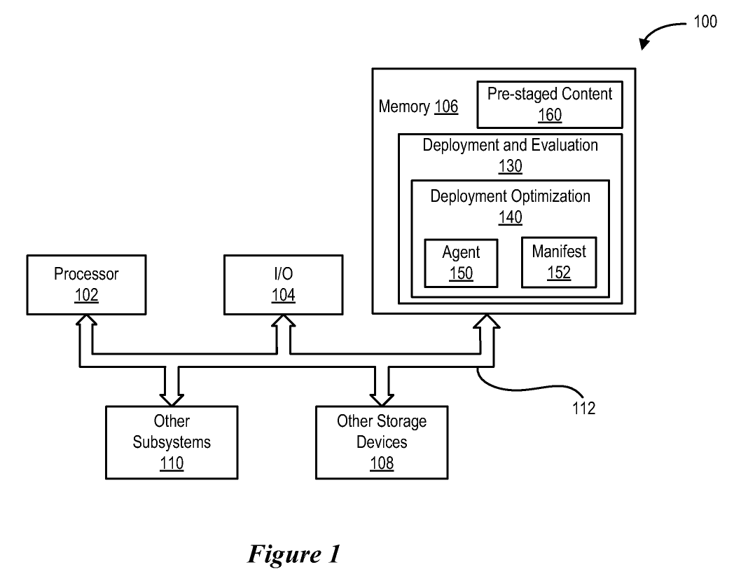

Referring to FIG. 1, a system block diagram of an information handling system 100 on which the deployment and evaluation tool is executed is shown. The information handling system 100 includes a processor 102, input/output (I/O) devices 104, such as a display, a keyboard, a mouse, and associated controllers, a memory 106 including non volatile memory such as a hard disk drive and volatile memory such as random access memory (RAM), and other storage devices 108, such as an optical disk and drive and other memory devices, and various other subsystems 110, all interconnected via one or more buses 112. A deployment and evaluation tool 130 is stored on the memory 106 and executed by the processor 102. The deployment and evaluation tool 130 includes a deployment optimization tool 140.

The information handling system 100 also includes pre-staged content stored on the memory 106

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

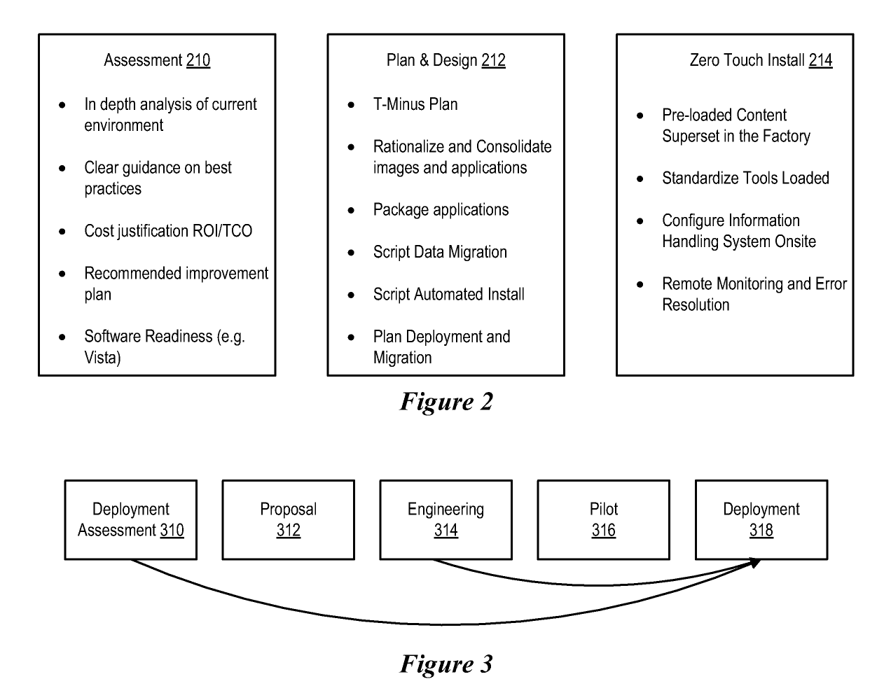

Referring to FIG. 2, a block diagram of the deployment and evaluation tool 130 is shown. More specifically, the deployment and evaluation tool 130 includes an assessment portion 210, a plan & design portion 212, and a zero touch install portion 214.

The assessment portion 210 provides an in depth analysis of a current customer information handling system environment. The assessment portion 210 also provides clear guidance to the customer regarding information handling system environment best practices. The assessment portion 210 also provides support for a deployment cost justification, both with respect to a deployment return on investment (ROI) and a total cost of ownership (TCO). The assessment portion 210 also provides a recommended improvement plan for customer information handing system environment. The assessment portion 210 also determines a software readiness of a current customer information handling system environment. The software readiness can determine, for example, the readiness of a current customer information handling system environment to effectively execute a new operating system such as the Microsoft Vista Operating System.

The plan & design portion 212 develops a recommended readiness (T-Minus) plan. The plan & design portion 212 also rationalizes and consolidates images and applications for install onto information handling systems that are to be deployed. The plan & design portion 212 also packages applications for the information handling systems being deployed. The plan & design portion 212 also develops a script data migration for the information handling systems being deployed. The plan & design portion 212 also develops an automated script install for the information handling systems being deployed. The plan & design portion 212 also develops a plan for the deployment and migration of the information handling system environment.

The zero touch install portion 214 generates a content superset for the content that is to be preloaded onto the information handling system and installs the content superset onto the information handling systems being deployed. The zero touch install portion 214 also develops and standardizes tools that are loaded onto the information handling system being deployed. The zero touch install portion 214 also enables onsite configuration of the deployed information handling systems. The zero touch install portion 214 also provides for remote monitoring and error resolution of deployed information handling systems.

Referring to FIG. 3, a flow diagram of the operation of the deployment tool 130 is shown. More specifically, the deployment and evaluation tool 130 begins operation by performing a deployment assessment at step 310. A proposal for an information handling system deployment environment is then developed at step 312. Once the proposal is accepted, engineering to develop the information handling system deployment environment is performed at step 314. Next, a pilot of the information handling system deployment environment is deployed at step 316. Next the information handling system deployment environment is deployed at step 318.

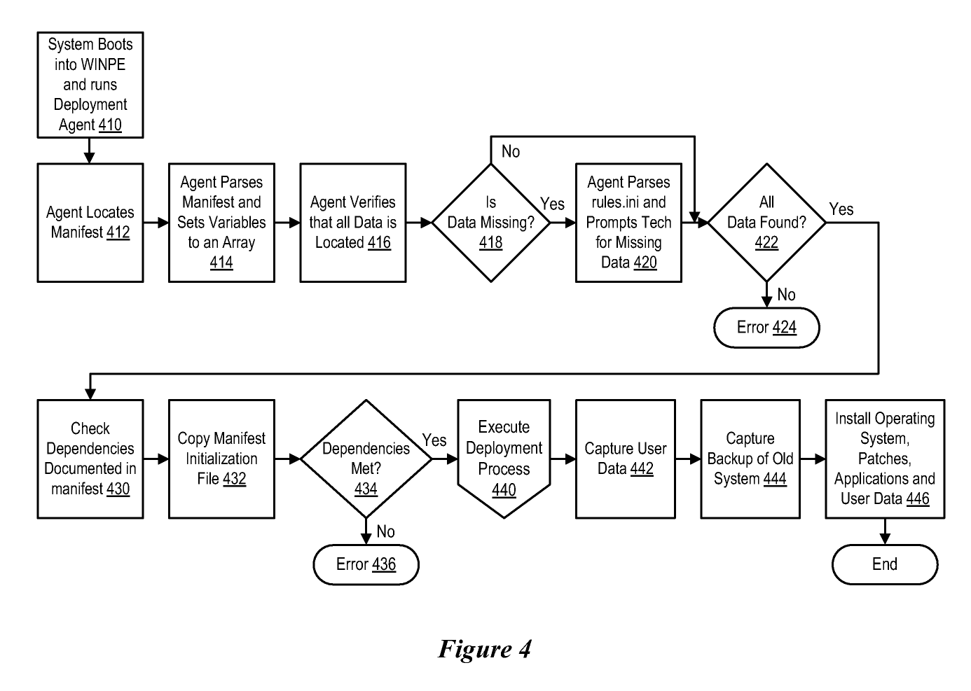

Referring to FIG. 4, a flow chart of the operation of the deployment optimization tool 140 is shown. More specifically, when the information handling system 100 is first booted at the customer site, the information handing system 100 boots into the WINPE, which in turn executes the deployment agent 150 at step 410. Next the deployment agent 140 locates the manifest 152 (which is for example an XML document (manifest.xml)) for the particular information handling system at step 412. The deployment agent 140 parses the manifest 152 and sets variables to a manifest variable array used by the deployment optimization tool 140 at step 414. Next the deployment agent 150 verifies that all data referenced by the manifest 142 has been located at step 416. If all data referenced by the manifest 142 is not located then the deployment optimization tool determines whether the data is missing at step 418.

If the deployment optimization tool determines that certain data is missing, then the deployment agent parses a rules file and prompts a technician to provide the missing data to the information handling system 100 at step 420. This prompt is typically in the form of a drop-down menu that displays multiple options to the technician. Often, a technician may have a backup copy of the data that is being used by the information handling system to facilitate an information handing system deployment. After the interaction with the technician, the deployment optimization tool 140 again determines whether all of the data identified by the manifest 152 has been located at step 422. If all of the data has not been located at this point, then the deployment optimization tool 140 indicates a data missing error has occurred during the information handling system deployment at step 424.

When all of the data identified by the manifest 152 has been located by the deployment optimization tool 140, the deployment optimization tool 140 then checks for data dependencies that are documented within the manifest 152 at step 430. Next, the manifest 152 is copied to an initialization file at step 432. This initialization file is used to drive the automation for the forthcoming processes.

Next, the deployment optimization tool 140 determines whether all of the dependencies identified within the manifest 152 have been met at step 434. If all of the dependencies identified within the manifest have not been met, then the deployment optimization tool 140 indicates a dependency error has occurred during the deployment of the information handling system at step 436.

When all of the dependencies have been met, then the deployment optimization tool executes a deployment process at step 440. The deployment process captures user data from the previous information handling system of the user to which the new information handling system is being deployed at step 442. Next the deployment process captures a backup of the previous information handling system of the user to which the new information handling system is being deployed at step 444. Next the deployment process installs the operating system, patches, applications and use data onto the information handling system being deployed at step 446 and then the deployment optimization tool completes installation.

The present invention is well adapted to attain the advantages mentioned as well as others inherent therein. While the present invention has been depicted, described, and is defined by reference to particular embodiments of the invention such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the deployment optimization model could include additional levels. The deployment optimization model could include additional factors.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or DVDs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for optimizing deployment of an information handling system comprising
loading a superset of content onto the information handling system;
generating a manifest representing content to be loaded onto the information handling system;
loading content from the superset of content based upon the manifest.

2. The method of claim 1, further comprising pre-staging the superset of content, and wherein
the superset of content comprises at least one of multiple customer images, multiple customer applications, data migration tools, and installation automation tools.

3. The method of claim 1, further comprising
storing a deployment front end on the information handling system; and,
upon booting the information handling system, executing the deployment front end, the deployment front end gathering data to drive deployment of the information handling system.

4. The method of claim 3, wherein
the deployment front end automatically moves user specific data from a previous user system onto the information handling system.

5. The method of claim 1, wherein
the loading occurs during fabrication of the information handling system.

6. An apparatus for optimizing deployment of an information handling system comprising
means for loading a superset of content onto the information handling system;
means for generating a manifest representing content to be loaded onto the information handling system;
means for loading content from the superset of content based upon the manifest.

7. The apparatus of claim 6, further comprising
means for pre-staging the superset of content, and wherein
the superset of content comprises at least one of multiple customer images, multiple customer applications, data migration tools, and installation automation tools.

8. The apparatus of claim 6, further comprising
means for storing a deployment front end on the information handling system; and,
means for executing the deployment front end, the deployment front end gathering data to drive deployment of the information handling system upon booting the information handling system.

9. The apparatus of claim 8, wherein
the deployment front end automatically moves user specific data from a previous user system onto the information handling system.

10. The apparatus of claim 6, wherein
the means for loading executes during fabrication of the information handling system.

11. An information handling system comprising:
memory coupled to the processor, the memory storing a deployment optimization tool for optimizing deployment of an information handling system, the tool including instructions for loading a superset of content onto the information handling system;
generating a manifest representing content to be loaded onto the information handling system;
loading content from the superset of content based upon the manifest.

12. The information handling system of claim 1 1, wherein the deployment optimization tool further comprises instructions for
pre-staging the superset of content, and wherein
the superset of content comprises at least one of multiple customer images, multiple customer applications, data migration tools, and installation automation tools.

13. The information handling system of claim 1 1, wherein the deployment optimization tool further comprises instructions for
storing a deployment front end on the information handling system; and,
upon booting the information handling system, executing the deployment front end, the deployment front end gathering data to drive deployment of the information handling system.

14. The information handling system of claim 13, wherein
the deployment front end automatically moves user specific data from a previous user system onto the information handling system.

15. The information handling system of claim 11, wherein
the instructions for loading execute during fabrication of the information handling system.
